(19) United States
(12) Patent Application Publication
(10) Pub. No.: US 2004/0202905 A1
(43) Pub. Date: Oct. 14, 2004

(54) Water powered fuel cell

(76) Inventor: Daniel H. Dingel, Huntington Beach, CA (US)

Correspondence Address: Lloyd Management Consultants, 3368 Sparkler Dr., Huntington Beach, CA, 92649, US

(21) Appl. No.: 10/411,868

(22) Filed: Apr. 14, 2003

(51) Int. Cl. H01M 8/18

(52) U.S. Cl. 429/21

(57) ABSTRACT

We have developed a working prototype of an alternative source of energy. The technology is one of using a water fuel system for the internal combustion engine, as well as other use which require the use of fossil fuels, nuclear energy, hydroelectric or other sources of energy. The system can be adapted, not only to automobiles, but to homes, offices, airplanes, jets, boats, and power utilities.

The system produces hydrogen gas and oxygen from water on demand. Water is separated into hydrogen and oxygen gas using a unique combination of metallurgical, electrical and design inventions. The hydrogen gas is then burned in a internal combustion engine, what hydrogen is not burned is returned in the system with oxygen and is returned to the water storage compartment. The hydrogen provides the explosion, like octane, to propel the cylinders in the internal combustion engine.

The system processes ordinary water, separating the hydrogen and oxygen, then utilizes the hydrogen as its fuel. The system used is a hydrogen gas generator powered by a 12-volt battery. The system produces hydrogen gas and oxygen from water on demand.

### CROSS-REFERENCE TO RELATED APPLICATIONS

N/A

### STATEMENT REGARDING FEDERALLY SPONSORED RESEARCH OR DEVELOPMENT

N/A

### REFERENCE TO SEQUENCE LISTING, A TABLE, ETC.

N/A

### BACKGROUND OF INVENTION

The design of this product was developed through over 30 years of research. The working prototype is now being used in a 1995 Toyota Corolla.

### BRIEF SUMMARY OF THE INVENTION

The invention produces hydrogen gas and oxygen from water on demand. The energy carrier gas is naturally aspirated by the engine vacuum via fuel line system. The system is replete with controls for hydrogen gas to propel the engine and deliver the horsepower, speed and torque needed for different velocity and road gradient. Because hydrogen gas is produced on demand, no storage for hydrogen is needed, thus eliminating the risk of explosion in the event of accidental collision.

1. We claim that we have invented a system whereby the source of energy based on using water as the fuel. We claim our invention produces hydrogen gas and oxygen form water on demand. The energy carrier gas is naturally aspirated by the engine vacuum via fuel line system. The system is replete with controls for hydrogen gas to propel the engine and deliver the horsepower, speed and torque needed for different velocity and road gradient. Because hydrogen gas is produced on demand, no storage for hydrogen is need, thus eliminating the risk of explosion in the event of accidental collision.
